(19) United States
(12) Patent Application Publication
(10) Pub. No.: US 2015/0175448 A1
(43) Pub. Date: Jun. 25, 2015

(54) SYSTEM FOR TREATING WASTEWATER CONTAINING BORON AND IODINE

(71) Applicant: Benq Materials Corporation, Guishan Township (TW)

(72) Inventors: Cheng-Lin CHUNG, Guishan Township (TW); Chun-Hsing CHEN, Guishan Township (TW); Chyi-Ching LIN, Guishan Township, Taoyuan County (TW)

(21) Appl. No.: 14/460,799

(22) Filed: Aug. 15, 2014

(30) Foreign Application Priority Data
Dec. 19, 2013 (TW) 102223981

(51) Int. Cl. C02F 1/469; C02F 1/28; B01D 29/56; C02F 1/44

(52) U.S. Cl. CPC C02F 1/469; C02F 1/441; C02F 1/285; B01D 29/56; C02F 2101/108

(57) ABSTRACT

A system for treating wastewater containing boron and iodine is provided. The system comprises a membrane filter, an electrodeionization filter and a resin adsorption column. The membrane filter is provided for removing iodine from the wastewater. The electrodeionization filter is connected to the membrane filter via lines for removing boron from the wastewater. The resin adsorption column is connected to the electrodeionization filter via lines for removing the residual boron from the wastewater. The boron and iodine can be removed efficiently to meet the wastewater discharging standard by using the system for treating wastewater containing boron and iodine.

### CROSS-REFERENCE TO RELATED APPLICATION

This application claims priority from Taiwan Patent Application No. 102223981, filed on Dec. 19, 2013, the contents of which are hereby incorporated by reference in their entirety for all purposes.

### BACKGROUND OF THE INVENTION

1. Field of the Invention

The present invention relates to a system for treating wastewater. More particularly, the present invention relates to a system for treating wastewater containing boron and iodine. The present system can be used to remove boron and iodine from wastewater efficiently.

2. Description of the Related Art

Liquid crystal display (LCD) is one of the well developed and widely used flat panel display. Liquid crystal display usually comprises a liquid crystal unit and two polarizers disposed on the two sides of the liquid crystal unit.

Generally, the polarizer is made by dying polyvinyl alcohol (PVA) with dichroic iodine or dye, and then crosslinking by boric acid.

However, iodine, potassium iodide and boric acid are commonly used in polarizer manufacturing process, and a wastewater would be produced therefore. According to current water discharging standard, the content of boron must be less than 10 ppm and the content of iodine must be less than 0 ppm in discharged water.

Several system for treating wastewater containing boron and iodine have been utilized to make the discharged wastewater to meet the discharging standard, such as, directing the wastewater into concentrating equipment, filtering by a plurality of reverse osmosis filters or filtering the wastewater after concentrating. However, the concentration of wastewater is conducted by heating treatment, which not only consumes a lot of energy but also increases manufacturing cost, and the chemicals in wastewater might further pollute the environment.

Therefore, there is still a need for a system for treating wastewater containing boron and iodine, which can remove boron and iodine effectively without heating treatment and make the wastewater stream to meet the wastewater discharging standard with a lower manufacturing cost.

### SUMMARY OF THE INVENTION

The present invention is to provide a system for treating wastewater containing boron and iodine for making the wastewater stream meet the wastewater discharging standard by removing boron and iodine. The present system can decrease the manufacturing cost, reuse of resources and protect the environment.

According to an aspect of the present invention, a system for treating wastewater containing boron and iodine is provided. The system is particularly used to treat wastewater discharged from polarizer manufacturing operations. The system comprises a membrane filter for removing iodine from the wastewater, an electrodeionization filter connected to the membrane filter via lines for removing boron from the wastewater and a resin adsorption column connected to the electrodeionization filter via lines for removing the residual boron from the wastewater.

In an embodiment of the present invention, the system for treating wastewater containing boron and iodine further comprises a mixing reaction tank connected to the electrodeionization filter and the resin adsorption column respectively via lines.

In an embodiment of the present invention, the system for treating wastewater containing boron and iodine further comprises a sludge press connected to the mixing reaction tank via lines.

In an embodiment of the present invention, the membrane filter is a reverse osmosis membrane filter.

In an embodiment of the present invention, the electrodeionization filter is a continuous electrodeionization filter.

In an embodiment of the present invention, the resin adsorption column is a chelating resin adsorption column.

In an embodiment of the present invention, the mixing reaction tank comprises a feeding area for feeding chemicals.

In an embodiment of the present invention, the feeding chemicals comprise sodium hydroxide, calcium hydroxide, phosphoric acid or pH adjusting agent.

The above and other aspects of the invention will become better understood with regard to the following detailed description of the preferred but non-limiting embodiment(s).

### BRIEF DESCRIPTION OF THE DRAWINGS

FIG. 1 is a block diagram of a preferred embodiment of the system for treating wastewater containing boron and iodine of the present invention.

### DETAILED DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details.

According to an aspect of the present invention, a system for treating wastewater containing boron and iodine is provided.

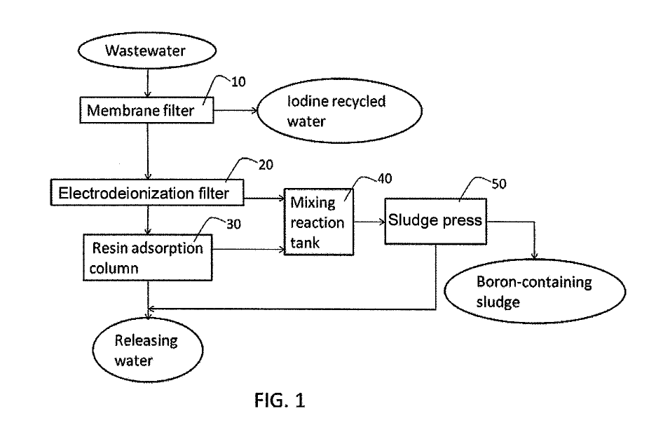

FIG. 1 is a block diagram of a preferred embodiment of the system for treating wastewater containing boron and iodine of the present invention. The system for treating wastewater containing boron and iodine as shown in FIG. 1 comprises a membrane filter 10, an electrodeionization filter 20 and a resin adsorption column 30.

When the wastewater containing boron and iodine is fed into the present system, the membrane filter 10 is used to remove iodine from the wastewater. In an embodiment of the present invention, the membrane filter 10 is a reverse osmosis (RO) membrane filter. Whether the molecule can be passed through the reverse osmosis membrane or not depends on the physical structure of the molecule itself. For example, a boron molecule can pass through a reverse osmosis membrane, but an iodine molecule cannot. Thus, iodine can be removed from the wastewater by the reverse osmosis membrane. In a preferred embodiment of the present invention, a scale inhibitor, such as sodium benzoate, can be added when iodine is removing by the reverse osmosis membrane filter to extend the life of membrane filter 10. The iodine removed by the reverse osmosis (RO) membrane filter can be recycled and reused by a method known to the person skilled in the art for further significant economic benefits.

The electrodeionization filter 20 is connected to the membrane filter 10 via lines for removing boron from the wastewater. In an embodiment of the present invention, the electrodeionization filter 20 is a continuous electrodeionization filter (CEDI). The electrodeionization filter 20 comprises anode electrode plate, cathode electrodes plate, ion exchange resins and ion exchange membranes. When the wastewater containing boron and iodine is passing through the electrodeionization filter 20, the borate ions in the wastewater are captured by the ion exchange resin, thus the wastewater is purified by deionization. By an electrical field to the electrodeionization filter 20, the captured ions pass through the ion exchange membranes and migrate and accumulate in the concentrating compartments. The water discharged from the concentrating compartments contains ions in a concentration approximately 10 to 20 times higher than that of the original feed wastewater. This ion-rich water may be drained, recycled, or reclaimed for further treatment. By applying an electrical current, water molecules are ionized into H+ ions and OH− ions for regenerating the ion exchange resin. Therefore, discharging water and regenerating the resin are continuously conducted. Continuous electrodeionization filter uses ion exchange resins as transfer medium, the ions from the feed wastewater can be migrated to the concentrated part continuously due to the application of an electrical current and the selection of ion exchange membranes. Therefore, the wastewater can be treated continuously. In an embodiment of the present invention, 80%-90% of boron can be removed by using continuous electrodeionization filter.

A resin adsorption column 30 is connected to the electrodeionization filter 20 via lines for removing the residual boron from the wastewater. In an embodiment of the present invention, the resin adsorption column 30 is a chelating resin adsorption column. Chelating resin is a macromolecular compound which can selectively adsorb specific ions in solution by forming ionic bonds or covalent bonds between chelating resin and ions. Suitable chelating resin adsorption column for removing boron can be, but not limited to, iminodiacetic acid chelating resin, polyamine chelating resin or meglumine chelating resin adsorption column.

Accordingly, when the present wastewater treatment system is associated with a polarizer manufacturing system, the wastewater from the polarizer manufacturing system can be directed into the membrane filter 10 of the present system to remove iodine. After removing iodine, the boron-containing wastewater is directed into the electrodeionization filter 20 to remove the most boron, and then the residual boron is further removed by resin adsorption column 30. An iodine concentration of the wastewater treated by the system for treating wastewater of the present invention will less than 1 ppm, thus, the treated water stream meets the wastewater discharging standard and can be discharged directly. No environment pollution will be caused accordingly.

In another embodiment of the present invention, the system for treating wastewater containing boron and iodine further comprises a mixing reaction tank 40. The mixing reaction tank 40 is connected to the electrodeionization filter 20 and the resin adsorption column 30 via respective lines, the boron-rich water respectively discharged by the electrodeionization filter 20 and the resin adsorption column 30 flows into the mixing reaction tank 40 for conducting a coagulation treatment, which is a chemical coagulation method.

The mixing reaction tank 40 comprises a feeding area for feeding chemicals to conduct a chemical coagulation treatment. The chemicals can be, but not limited to, sodium hydroxide, calcium hydroxide, phosphoric acid, pH adjusting agent or a combination thereof. Calcium hydroxide can be used as mineralizing agent to form calcium metaborate by precipitating borate from the boron-rich water. When adding calcium hydroxide and phosphoric acid, phosphoric acid and calcium hydroxide combine together to form hydroxyapatite to cover the calcium metaborate, this can prevent the calcium metaborate to be dissolved again. The pH value of the mixing reaction tank 40 can be adjusted within a range of from 9 to 11 by adding sodium hydroxide to facilitate the above reaction. The reaction time of the boron-rich water in the mixing reaction tank 40 can be, but not limited to, from 5 minutes to 1 hour.

In further another embodiment of the present invention, the system for treating wastewater containing boron and iodine further comprises a sludge press 50. The sludge press 50 is connected to the mixing reaction tank 40 via lines. After the boron-rich water is treated by chemical coagulation treatment in the mixing reaction tank 40, the boron-containing sludge passes into sludge press 50 to conduct a dewatering treatment. After the dewatering treatment, the boron-containing sludge can be further treated by incinerating, burying or curing. And the water from the dewatering can be discharged directly.

From the forgoing, the system for treating wastewater containing boron and iodine according to the present invention can efficiency remove the boron and iodine from the wastewater discharged from the polarizer manufacturing operations. In addition, compared to conventional techniques, the system for treating wastewater containing boron and iodine according to the present invention do not involve heating and concentrating treatment, therefore the manufacturing cost can be reduced and the filtered product can be efficiently recycled and provide significant economic benefits.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for treating wastewater containing boron and iodine comprising:
a membrane filter for removing iodine from the wastewater;
an electrodeionization filter connected to the membrane filter via lines for removing boron from the wastewater; and
a resin adsorption column connected to the electrodeionization filter via lines for removing the residual boron from the wastewater.

2. The system for treating wastewater containing boron and iodine according to claim 1 further comprising a mixing reaction tank connected to the electrodeionization filter and the resin adsorption column respectively via lines.

3. The system for treating wastewater containing boron and iodine according to claim 2 further comprising a sludge press connected to the mixing reaction tank via lines.

4. The system for treating wastewater containing boron and iodine according to claim 1, wherein the membrane filter is a reverse osmosis membrane filter.

5. The system for treating wastewater containing boron and iodine according to claim 1, wherein the electrodeionization filter is a continuous electrodeionization filter.

6. The system for treating wastewater containing boron and iodine according to claim 1, wherein the resin adsorption column is a chelating resin adsorption column.

7. The system for treating wastewater containing boron and iodine according to claim 2, wherein the mixing reaction tank comprising a feeding area for feeding chemicals.

8. The system for treating wastewater containing boron and iodine according to claim 7, wherein the chemicals comprise sodium hydroxide, calcium hydroxide, phosphoric acid or pH adjusting agent.
